(19) United States
(12) Patent Application Publication
(10) Pub. No.: US 2012/0018603 A1
(43) Pub. Date: Jan. 26, 2012

(54) Temporary Attachment Device For a Mounting Assembly

(76) Inventor: Jack R. Kerr, JR., College Station, TX (US)

(21) Appl. No.: 13/191,387

(22) Filed: Jul. 26, 2011

Related U.S. Application Data
(60) Provisional application No. 61/367,519, filed on Jul. 26, 2010.

(51) Int. Cl. F16M 13/02; B23P 11/00

(52) U.S. Cl. 248/222.14; 29/525.11; 248/220.21; 248/224.8

(57) ABSTRACT

A mounting assembly having a box. The box includes a plurality of walls and an interior. The mounting assembly also includes a temporary retaining device for temporarily retaining the box upon a support surface. The temporary retaining device includes at least two arms for engaging each side of the support surface for temporarily retaining the box upon the support surface. The mounting assembly also includes a fastener for permanently fastening the box to the support surface. In one embodiment, the fastener is a screw positioned within a fastener orifice. The fastener orifice includes a material for retaining the screw in the fastener orifice.

### RELATED APPLICATIONS

This utility application claims the benefit of U.S. Provisional patent application Ser. No. 61/367,519 filed Jul. 6, 2010 by Jack R. Kerr, Jr., which is hereby incorporated by reference.

### BACKGROUND OF THE INVENTION

1. Field of the Invention:

This invention relates to support assemblies. Specifically, and not by way of limitation, the present invention relates to a temporary attachment device for a mounting assembly for supporting electrical boxes.

2. Description of the Related Art:

In construction of houses and buildings, it is quite common to have electrical boxes mounted to the walls or ceilings. These electrical boxes provide support and storage of various wiring devices, lighting fixtures, fans, and many other devices useful in a building. Electrical boxes also provide a space for electrical connections between the wiring device or fixture and the wiring of the building. These electrical boxes are normally attached to one or more structural supports, such as joists or studs. Often the electrical boxes include brackets for directly attaching the electrical box to the support member, while other electrical boxes are attached to a hanger or other support assembly which extends between a pair of adjacent structural supports.

Oftentimes, conventional electrical boxes are attached to an object, such as a stud in a wall by using fasteners, such as screws. The conventional electrical boxes or junction boxes often include holes through which a screw or other fastener is inserted for securing the electrical box to the supporting surface.

However, the task of affixing the electrical box to the supporting surface can be cumbersome. Frequently, the electric box must be attached in an area above the installer's head. The installer must first locate and align the electrical box in its correct intended position. The installer must then maintain the correct position of the electrical box while attempting to fasten a screw or hammer a nail into the support surface.

Thus, the installation of these existing electrical boxes can be extremely difficult. Even experienced installers have tremendous difficulty when attempting to install the electrical box to the supporting surface when the electrical box is located in awkward overhead locations.

Therefore, it would be advantageous to have a mounting assembly which is easily installed, even in awkward overhead locations. It is an object of the present invention to provide such an apparatus.

### SUMMARY OF THE INVENTION

In one aspect, the present invention is a mounting assembly having a box. The box includes a plurality of walls and an interior. The mounting assembly also includes a temporary retaining device for temporarily retaining the box upon a support surface. The temporary retaining device includes at least two arms for engaging each side of the support surface for temporarily retaining the box upon the support surface. The mounting assembly also includes a fastener for permanently fastening the box to the support surface. In one embodiment, the fastener is a screw positioned within a fastener orifice. The fastener orifice includes a material for retaining the screw in the fastener orifice.

In another aspect, the present invention is directed to a method of mounting a box to a support. The method begins by positioning a screw through a fastener orifice of the box. Next, At least two moveable attachment arms located on the box are positioned on opposing sides of the support. The screw is then screwed into the support. The attachment arms may be optionally removed from the sides of the support.

### BRIEF DESCRIPTION OF THE DRAWINGS

FIG. 1 is a front perspective view of an electrical box in the preferred embodiment of the present invention;

FIG. 2 is a top perspective view of the electrical box of FIG. 1;

FIG. 3 is a bottom perspective view of the housing;

FIG. 4 is a second bottom perspective view of the housing with one of the screws removed;

FIG. 5 is a side view of the electrical box attached to a support;

FIG. 6 is a side view of one attachment arm engaging the support; and

FIG. 7 is a flow chart illustrating the steps of attaching the electrical box to the support according to the teachings of the present invention

### DESCRIPTION OF THE INVENTION

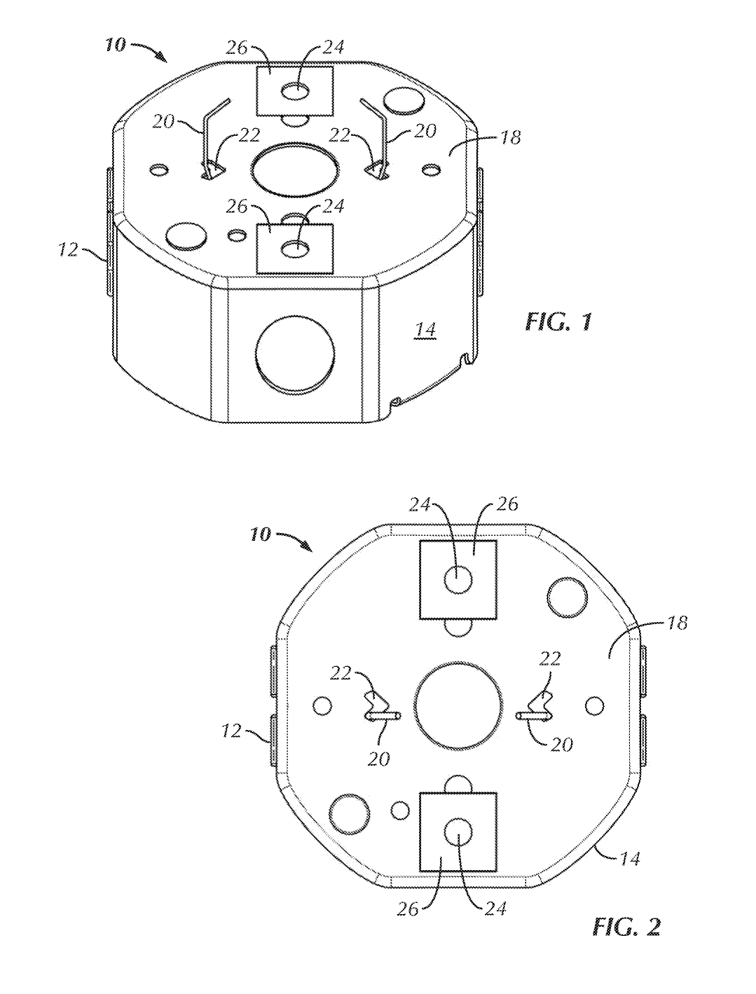

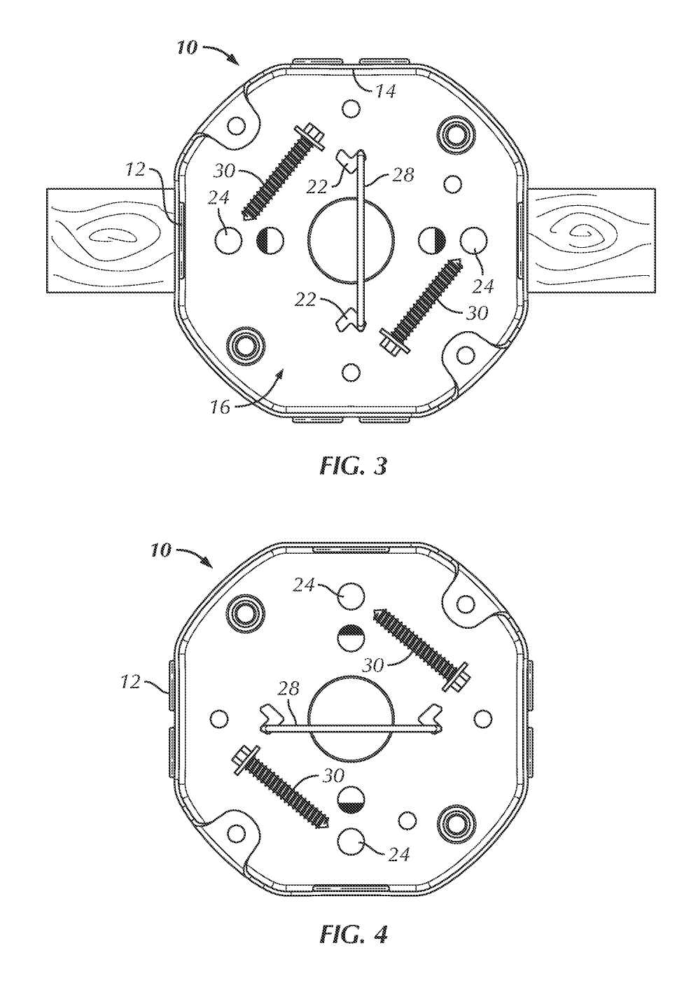

The present invention is a temporary attachment apparatus for a mounting assembly. FIG. 1 is a front perspective view illustrating an electrical box 10 in the preferred embodiment of the present invention. FIG. 2 is a top perspective view illustrating the electrical box 10 of FIG. 1. The electrical box 10 includes a housing 12 having vertical side walls 14 surrounding an interior 16 (shown in FIG. 3) and an upper surface 18. Upon the upper surface 18 of the electrical box is at least two attachment arms 20. The attachment arms extend through orifices 22 on the upper surface. Two or more fastener orifices 24 are located on the upper surface 18. Each fastener orifice is covered with a material 26 which may be pierced by a screw or nail, such as a heavy paper or thin plastic material. In one embodiment, the material 26 includes a rough upper surface (e.g., sandpaper) for frictionally engaging another surface.

FIG. 3 is a bottom perspective view illustrating the housing 12. The attachment arms are positioned through the orifices 22 and connect at a main rod 28. Thus, in the preferred embodiment of the present invention, the attachment arms are a single integral wire material with each attachment arm protruding through the orifices 22. However, in an alternate embodiment of the present invention, the attachment arms are not connected and are affixed separately at the orifices 22. Fasteners or screws 30 are positioned through the fastener orifices 24. FIG. 4 is a second bottom perspective view of the housing 12 with one of the screws 30 removed. Covering the fastener orifice 24 is the material 26, which is positioned on the outer upper surface 18 of the housing (not shown in FIG. 4).

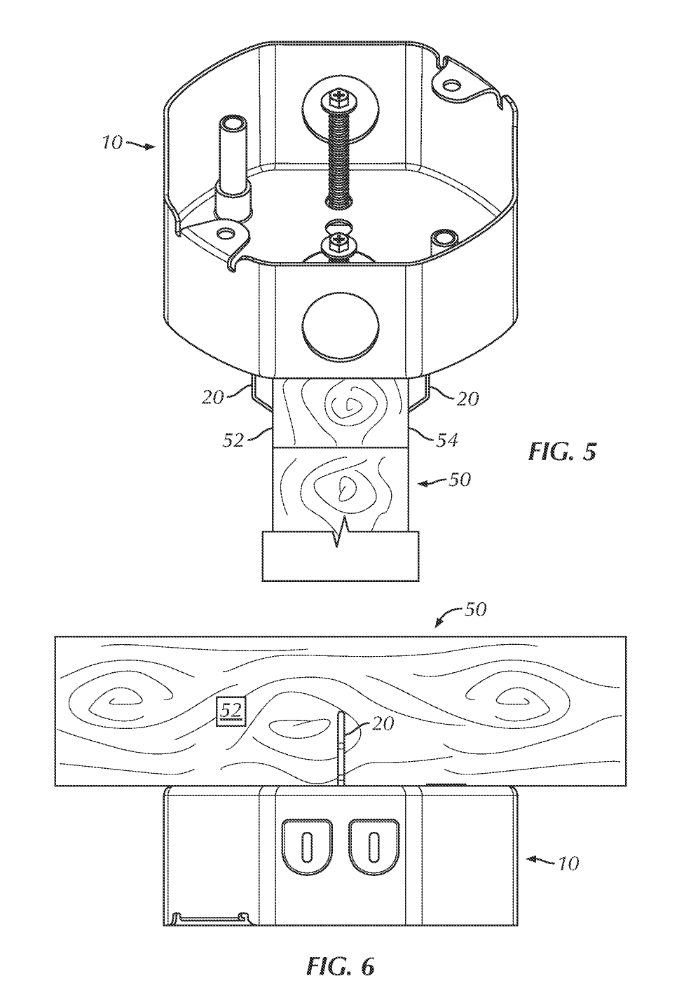

FIG. 5 is a side view of the electrical box attached to a support 50. FIG. 6 is a side view of one attachment arm 20 engaging the support 50. To facilitate the attachment of the electrical box 10 to the support 50, the attachment arms engage each side 52 and 54 of the support 50.

With reference to FIGS. 1-6, the operation of the present invention will now be explained. Prior to attaching the electrical box 10 to the support 50, screws 30 are positioned through the interior 16 into the fastener orifices 22. The screws are inserted sufficiently to pierce the material 26 and be retained in the fastener orifice without extending far beyond the upper surface 18. The attachment arms are moveable and rotatable to adjust to different positions and sizes of the support. The attachment arms are rotated and extended as necessary to engage each side 52 and 54. The arms provide inward force to engage and hold the electrical box upon the support 50 without being held by the installer. With the electrical box properly positioned and held in place by the attachment arms, the installer may fasten (screw) the screws into the support 50, thereby permanently affixing the electrical box 10 to the support 50. Since the screws have been positioned into the material 26, the installer does not have to search, retrieve and position the screws into the fastener orifices. The attachment arms may remain in place or removed as desired by the installer. Although the present invention is described in terms of an electrical box, the present invention may be utilized on any support device, such as a mounting bracket, a junction box, etc.

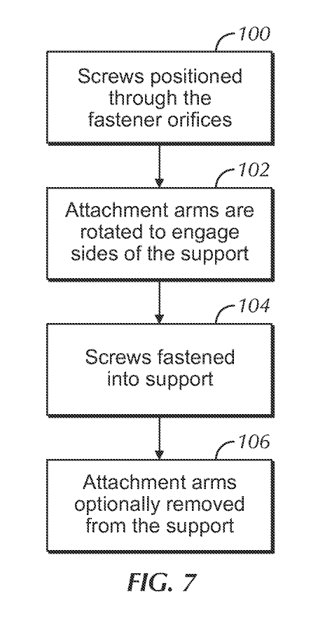

FIG. 7 is a flow chart illustrating the steps of attaching the electrical box 10 to the support 50 according to the teachings of the present invention. With reference to FIGS. 1-7, the method of the present invention will now be explained. In step 100, prior to attaching the electrical box 10 to the support 50, screws 30 are positioned through the interior 16 into the fastener orifices 22. The screws are inserted sufficiently to pierce the material 26 and be retained in the fastener orifice without extending far beyond the upper surface 18. Next, in step 102, the attachment arms are rotated and extended as necessary to engage each side 52 and 54 of the support 50. The arms provide inward force to engage and hold the electrical box upon the support 50 without being held by the installer. With the electrical box properly positioned and held in place by the attachment arms, the installer fastens (screw) the pre-positioned screws into the support 50, thereby permanently affixing the electrical box 10 to the support 50 in step 104. In step 106, the attachment arms are optionally removed or rotated away from the support as desired by the installer. Although the present invention is described in terms of an electrical box, the present invention may be utilized on any support device, such as a mounting bracket, a junction box, etc.

The present invention provides many advantages over existing devices. The present invention provides a simple and efficient way of securing an electrical box to any support surface. The present invention enables an installer to temporarily affix the electrical box while fastening screws or fasteners to the support surface. The present invention also enables the installer to pre-position the screws into the electrical box, thereby easing the workload for the installer.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A mounting assembly for mounting a box to a support, the mounting assembly comprising:
a box having a plurality of walls and an interior;
a temporary retaining device for temporarily retaining the box upon a support surface, the temporary retaining device having at least two arms for engaging each side of the support surface for temporarily retaining the box upon the support surface; and
a fastener for permanently fastening the box to the support surface.

2. The mounting assembly according to claim 1 wherein the fasteners are screws which are held in place upon fastener orifices located on an upper surface of the box.

3. The mounting assembly according to claim 1 wherein the box is an electrical box.

4. The mounting assembly according to claim 1 wherein the box is a junction box.

5. The mounting assembly according to claim 1 wherein the box includes fastener orifices sized and shaped for affixing fasteners to the box and support surface.

6. The mounting assembly according to claim 5 wherein the fastener is a screw.

7. The mounting assembly according to claim 6 wherein the fastener orifice is covered by a retaining material, the retaining material retaining a screw in the fastener orifice.

8. The mounting assembly according to claim 7 wherein the retaining material includes a rough surface.

9. The mounting assembly according to claim 1 wherein the arms are moveable.

10. The mounting assembly according to claim 9 wherein the retaining device includes two opposing arms, each arms spaced sufficiently to contact each side of the support.

11. The mounting assembly according to claim 10 wherein the two arms are a single integral wire.

12. A method of mounting a box to a support, the method comprising the steps of:
positioning a screw through a fastener orifice of the box;
positioning at least two moveable attachment arms located on the box to opposing sides of the support; and
screwing the screw into the support.

13. The method according to claim 12 wherein the step of positioning a screw through a fastener orifice includes retaining the screw in the fastener orifice with material located over the fastener orifice.

14. The method according to claim 12 wherein the two opposing arms are spaced sufficiently to contact each side of the support.

15. The method according to claim 12 further comprising the step of removing the attachment arms from the sides of the support.
